(19) United States
(12) Patent Application Publication
(10) Pub. No.: US 2004/0249815 A1
(43) Pub. Date: Dec. 9, 2004

(54) License management system and method for playing contents on home network

(75) Inventor: Sun-nam Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/855,505

(22) Filed: May 28, 2004

(30) Foreign Application Priority Data
Jun. 5, 2003 (KR) 10-2003-0036348

(51) Int. Cl. G06F 17/30

(52) U.S. Cl. 707/9

(57) ABSTRACT

A system and a method for allowing a plurality of devices interconnected for home networking to use the contents only by a single license without acquiring separate licenses for the devices. A transceiver module transmits/receives data to/from various devices. A license search module receives a request to issue a license from a home device through the transceiver module, searches for a corresponding formal license in a license storing module, and transmits the search result to both a license request module and a temporary license issuing module. The license request module requests the license server to issue the corresponding formal license when the formal license does not exist in the license storing module, and stores the license downloaded from the license server. The temporary license issuing module issues a temporary license to the corresponding home device through the transceiver module, based on the formal license stored in the license storing module.

### BACKGROUND OF THE INVENTION

This application claims foreign priority under 35 USC 119 to Korean Patent Application No. 10-2003-0036348, filed on Jun. 5, 2003, the contents of which is incorporated herein by reference.

1. Field of the Invention

The present invention relates to a system and a method for providing technologies available for transmitting encrypted contents from a content provider to users and preventing illegal reproduction of the transmitted contents in the Internet environment, and more particularly, to a system and a method for allowing a plurality of devices interconnected for home networking to use the contents only by use of a single license without acquiring separate licenses for the devices interconnected within the home network.

2. Description of the Related Art

As shown in FIG. 1, a related art Digital Rights Management (DRM) system comprises a Web server distributing media files, a license server assigning licenses corresponding to respective devices, and a device playing media files downloaded from the Web server, based on the licenses granted thereto as authenticated by the license server. Where a personal computer (PC) exists only in one place, there is no problem or restriction in use of such a related art DRM system.

Currently, a plurality of devices as are in the home network frequently play the same contents, but the related art DRM system has not considered the currently prevailing concept of home networking and has assigned different licenses to respective devices, thereby having caused inconvenience to users.

In this regard, referring to FIG. 1, it is impossible to apply the same license to the same media files that both the first and the second devices have in common.

However, the related art has various problems and disadvantages. For example, but not by way of limitation, the related art DRM system is disadvantageous in that, when it is applied to home networking, separate licenses must be assigned to the respective devices within the home network. In general, since homes devices interconnected for home networking should be able to share all the contents on the home network among them and each of the devices should also be able to play such contents, there is a need to correct the current DRM architecture.

### SUMMARY OF THE INVENTION

To solve the above problems occurring in the prior art, one object of the present invention is to eliminate any inconveniences caused during repackaging or redistribution when the license is changed, by separating a license from a media and independently storing the separated license, which is then checked in an independent manner at the time of playing the media, for secure distribution of digital media.

Another object of the present invention is to provide a method for allowing a variety of devices for the home networking to share a single license, to solve a related art problem in which the devices are assigned separate licenses in the home network existing therein the variety of devices.

To accomplish these and other objects, a license management apparatus for playing contents on a home network, including a license storing module that stores at least one license provided from a license server, and a temporary license issuing module that issues at least one temporary license for use by at least one home device within the home network, based on the at least one formal license stored in the license storing module. Also provided is a license management system for playing contents on a home network, including a license server assigning at least one license corresponding to a device and contents, a Web server providing a service to download the contents, and at least one home device, provided with a content player for playing a media file using the contents downloaded from the Web server and the at least one license assigned from the license server. Also included is a license management module allowing the at least one license assigned from the license server to be shared on the home network.

Further, the present invention provides a license management method for playing contents for home networking, comprising the steps of a) a home device requesting a license from a license management module, b) determining whether the license exists in the license management module, c) assigning a temporary license to the home device in accordance with the determination result, and d) playing the contents by use of a content player in the home device. The foregoing steps can also be implemented in a computer-readable medium.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram showing a related art process for issuing a license to play contents;

FIG. 2 is a block diagram showing the entire construction of a license management system according to an exemplary, non-limiting embodiment of the present invention;

FIG. 3 is a block diagram showing a construction to share a license in the home network when a user desires to play contents received through a downloading service according to an exemplary, non-limiting embodiment of the present invention;

FIG. 4 is a block diagram showing a construction to share a license in the home network when a user desires to play contents received through a streaming service according to an exemplary, non-limiting embodiment of the present invention;

FIG. 5 is a block diagram showing operation of components of a license management module according to an exemplary, non-limiting embodiment of the present invention;

FIG. 6 is a flowchart showing the entire process of a license management method according to an exemplary, non-limiting embodiment of the present invention; and

FIG. 7 is a flowchart showing steps of the license management method of the present invention, on the basis of home networking according to an exemplary, non-limiting embodiment of the present invention.

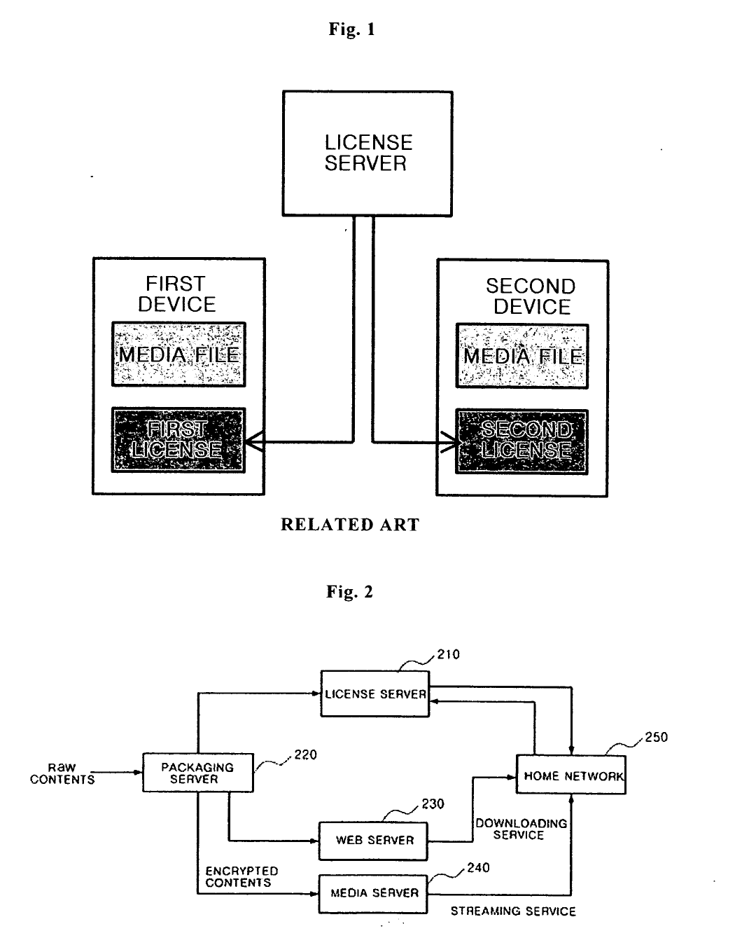

### DESCRIPTION OF THE PREFERRED EMBODIMENTS

Digital Rights Management (DRM) is an inclusive system for supporting security as well as copyrights management of the overall digital contents. For this purpose, a server-based security processing is first considered. For example, but not by way of limitation, there may be considered methods of allowing only a user having acquired specific rights to access a server and download a media file, or to receive a media stream transmitted in real-time to play contents.

However, since the contents, downloaded once, can be instantly distributed through a Peer-to-Peer (P2P) search function at high speed, digital contents cannot be protected in a secure manner with only the server-based security processing unless the files as exchanged are processed for security.

Further, a method of manipulating data bits in a header part of a media file may be considered. However, this method is not proper for security processing, because it is highly liable to be exposed to a risk of hacking and the service provision may be insecure due to the manipulation of media files not being not verified.

Meanwhile, use of a watermarking method may also be considered. However, this method is employed to find an original writer or the origin of contents when the contents are appropriated without authorization. Since the watermarking method is a copyright management method rather than a security method, it is not possible to prohibit an unauthorized user from using the contents.

Therefore, it is preferable to use a content security method with which a license can be established by a variety of combinations of setting the number of viewings, setting of a valid playing time and a free viewing period and time, encryption of the file itself, and issuance and verification of the license proper to the concerned device (e.g., PC, Personal Digital Assistant (PDA) or the like). Further, this method can be applied to both security for stream accessing and general security for media files. Also, super distribution that allows media files to be spread through reproduction between users contributes to an increase in sales by a service provider.

Hereinafter, an exemplary, non-limiting embodiment of the present invention is described in detail with reference to the accompanying drawings.

FIG. 2 is a block diagram showing the entire construction of a license management system according to an exemplary, non-limiting embodiment of the present invention. A packaging server 220 encrypts raw contents (i.e., raw media files) by use of a license key, and a Web server 230 provides a service to enable individual devices to download the encrypted media files. Also, a media server 240 provides media streams to enable the individual devices to play the encrypted media files in real-time, and a license server 210 receives a request from a home device to identify the hardware ID unique to the home device, and issues a license to enable only the home device to play corresponding contents therein.

The packaging server 220 packages raw contents provided from a content provider and Meta data such as (but not limited to) a license key, and transmits the packaged contents to the Web server 230 or the media server 240. For protecting and maintaining the contents through the packaging process, the packaging server 220 generates locks for a variety of media files using the license key and generates a 64-bit encrypted license, thereby enabling files to be distributed in a secure manner.

The content provider executes the packaging process by combining a license key seed and a key ID together through the packaging server 220, and consequently generates encrypted media files. A detailed description of the packaging process can be referred to in Microsoft (MS) DRM homepage “http://www.microsoft.com/windows/windowsmedia/wm7/drm/architecture.aspx” or “http://www.microsoft.com/windows/windowsmedia/wm7/DRM/tutorial.aspx.”

The Web server 230 provides a service to download media files. The Web server 230 can be operated by the same entity as the content provider, or alternatively, by a separate service provider responsible only for data distribution. Further, the media server 240 provides a service to stream media files. Similar to the Web server 230, the media server 240 can be operated by the same entity as the content provider or alternatively, a different entity. As a result, the contents are widely distributed to a plurality of device users by the Web server 230 and the media server 240.

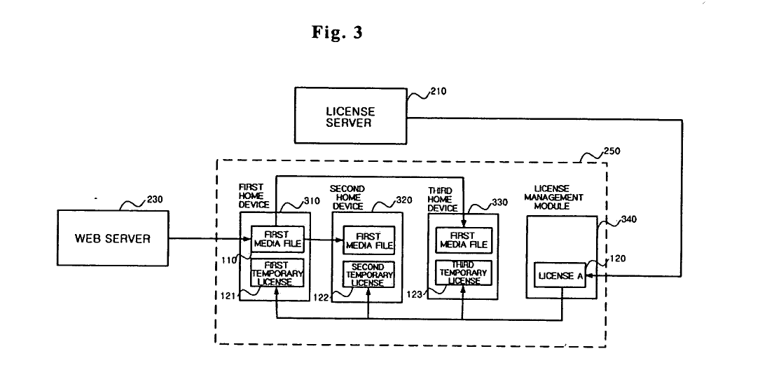

The home network 250 comprises at least one of a plurality of home devices, and further comprises a license management module, one component included in the present invention. An operation of the license management module 340 will be described in detail with reference to FIGS. 3 to 5.

The license server 210 assigns a license to use the contents and performs continuous management of the license. The license server 210 includes a first unit for processing payment by a user relative to his use of the contents, a second unit for issuing and managing a license containing therein the license information, and a third unit for collecting the use particulars of the users and gathering the statistics thereof.

An unlicensed device must acquire a license for use of the contents in order to execute them. When each device transfers an identification (ID) of a content player playing the contents as desired by the device and a hardware ID (for example, but not by way of limitation, MAC address) thereof to the license server 210, the license server 210 generates and issues a license unique to each device.

Through the aforementioned individualization process, the license server 210 can take an action to prohibit a license from being issued, when necessary, since the license can be checked whether information of a player has been modulated in the licensing process, even though the user has modulated the player in a random manner.

Further, since each license is issued only to a corresponding device, reproduction of the licenses has no significance, and therefore, the licenses are managed in a secure manner. Referring to a license creation process, the license server 210 creates a license by combining a license key seed with a key ID from a media file encrypted by the packaging server 220. Media file packaging and license issuing can be performed by a separate organization or association by allowing a public key to be shared. A detailed description of the licensing process can be referred to in MS DRM homepage “http://www.microsoft.com/windows/windowsmedia/wm7/drm/architecture.aspx” or “http://www.microsoft.com/windows/windowsmedia/wm7/DRM/tutorial.aspx.”

FIG. 3 is a block diagram of an exemplary, non-limiting embodiment of the present invention, showing a construction to share a license in the home network when a user desires to play contents received through a downloading service. According to this embodiment, the license management system comprises a Web server 230 distributing media files, a license server 210 assigning licenses proper for respective device and contents, a license management module 340 enabling the licenses assigned from the license server 210 to be shared on the home network, and home devices 310, 320 and 330, each having a content player for playing media files downloaded from the Web server 230, using each of the licenses issued from the license server 210.

FIG. 3 illustrates a case where the first home device 310 downloads a first media file 110 thereonto from the Web server 230 and desires to play the first media file 110. In this case, the second home device 320 can download the first media file 110 existing in the first home device 310 thereonto and play it, and the third device 330 can directly play the first media file 110 existing in the first home device 310 in a stream format. In this case, the license management module 340, requested to issue a license from the first home device 130, receives a license “A” 120 downloaded from the license server 210, and stores the license “A” 120 therein so as to play the first media file 110.

Thereafter, the license management module 340 issues temporary licenses to respective home devices based on the downloaded license “A” 120. The respective home devices can play the same media file using their respective temporary licenses. When the license policy is established to limit the number of viewings, the license expires and the media file can not be played any longer when the total number of times the media file has been played by the respective home devices reaches the limited number under the license policy.

Further, where is established to limit a valid playing time under the license policy, when the total time spent playing the media file reaches the limited time of period, the license expires and is not renewed. Moreover, if it is established to limit the allowable number of reproductions under the license policy, the total number of reproductions performed between the respective home devices is used as a reference for expiration of a license.

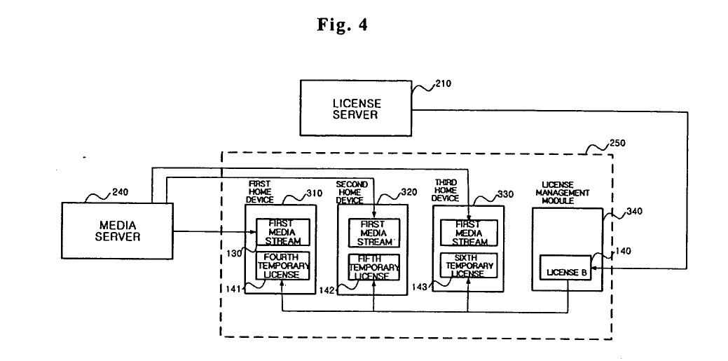

FIG. 4 is a block diagram showing a construction to share a license in the home network when a user desires to play contents received through a streaming service. Similar to the system illustrated in FIG. 3, a system according to this embodiment of the present invention comprises the license server 210, the license management module 340, and the home devices 310, 320 and 330. However, in lieu of the Web server 240, the media server 240 provides a streaming service for media files.

When the plurality of home devices 310, 320 and 330 receive a media stream 130 from the media server 240 and desire to play it in real-time, the license management module 340 receives a first request to issue a license from one of the home devices, downloads a license “B” 140 thereonto from the license server 210 and stores the license therein to play the first media stream 130. Thereafter, the license management module 340 issues temporary licenses to the respective home devices based on the downloaded license “B” 140. The respective home devices can then play the same media stream using their respective temporary licenses. As described in FIG. 3, when the number of times the home devices have played the media stream reaches the limited number of time, or when the total time used in playing the media stream reaches the limited time, the license expires.

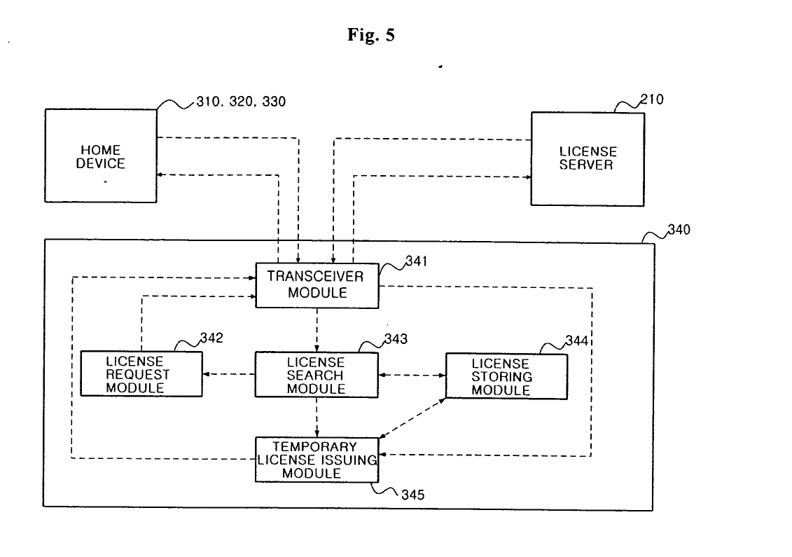

FIG. 5 is a block diagram showing operation of components of a license management module according to an exemplary, non-limiting embodiment of the present invention. The license management module 340 requests that the license server 210 license all media files or media streams on the home network, and creates and issues temporary licenses based on the licenses downloaded from the license server 210.

The license management module 340 enables the licenses downloaded from the license server 210 to be used in the respective devices. The license management module 340 can be provided by a content provider to allow the home network user to share the licenses. Therefore, a method employed when the license server 210 issues a license can be applied to the license management module 340.

When the respective home devices request licenses from the license management module 340 while transferring content player IDs and hardware IDs to a license storing module 344, the license management module 340 requests the license server 210 to issue the license, acquires and stores the licenses, and then issues temporary licenses unique to the respective devices.

The license management module 340 includes a transceiver module 341, a license request module 342, a license search module 343, the license storing module 344, and a temporary license issuing module 345. The transceiver module 341 accepts a request to issue a license from a home device, transmits the license issuing request to the license server 210, and downloads thereonto a formal license (herein, a license issued from the license server 210 can be designated as the formal license, in comparison with a temporary license) issued from the license server 210.

Further, the transceiver module 341 transmits unique temporary licenses to the respective devices. The license search module 343 searches the license storing module 344 to determine whether the corresponding formal license has been already stored therein, after receiving the license issuing request from the concerned home device, and transmits the search result to both the license request module 342 and the temporary license issuing module 345.

The license storing module 344 stores the formal licenses downloaded from the license server 210 through the transceiver module 341. The license request module 342 requests the license server 210 to issue a corresponding formal license through the transceiver module 341, when the formal license corresponding to the home device and contents does not exist in the license storing module 344. Further, the temporary license issuing module 345 issues temporary licenses based on the formal license stored in the license storing module 344 through the transceiver module 341 to allow other home devices to use media files or media streams.

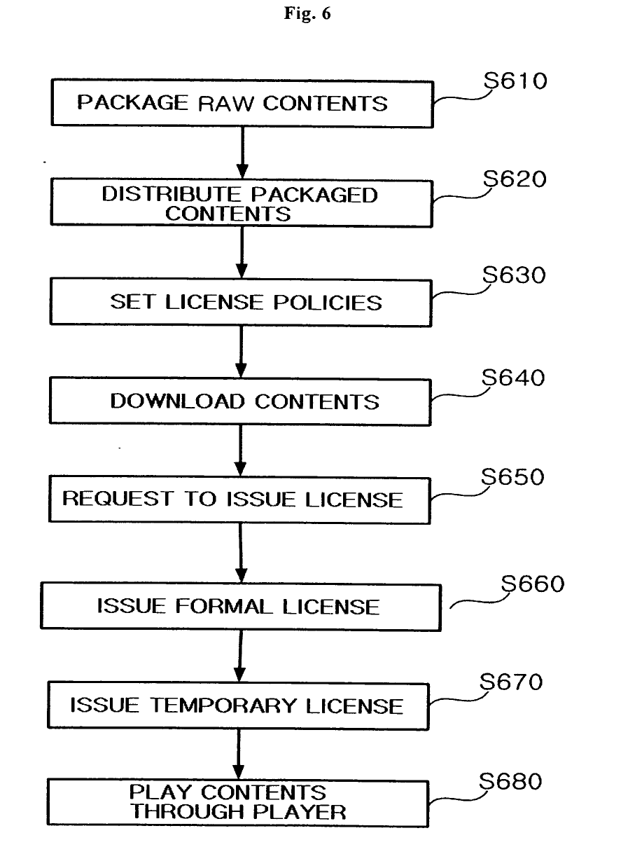

FIG. 6 is a flowchart showing the entire process of an exemplary, non-limiting embodiment of a license management method according to the present invention. First, raw contents encrypted by a content provider and a license key are packaged together so as to generate encrypted contents at step S610. Next, the encrypted contents are distributed to users through the Web server or the media server at step S620. In step S620 purchase and usage of contents defined in view of type and demands by users of various services are supported.

It was sufficient that the early DRM considered the distribution of contents to be limited only to terminals that download the contents at the time of distributing the contents. Currently, digital contents can be distributed through the movement (that is, super distribution) to various devices on the home network, or various terminals belonging to a user, through a roaming process. In the latter case, since contents and a license therefor are separated, access to the packaged contents is freely permitted. However, the license concerned must be issued when the contents are actually used, thus preventing illegal reproduction in a secure manner. Next, the license policy is set up at step S630.

The license policy can be set up by several combinations of setting of the number of viewings, setting of a valid playing time and a free viewing period and time, setting of the number of possible reproductions and the like, depending upon the policy of a content provider. At this time, on-line service types, such as moving image streaming services, as well as off-line service types to download files in a conventional manner, can be taken into consideration. In the case of on-line services, information related to content usage rules, encoding or the like can be stored in a server, and the control ability of the license for use of the contents can be improved, and the procedure of license processing in the home network can be simplified due to the dynamic variation of usage rules.

Next, the contents are downloaded onto a home device at step S640, and the license management module requests the license server to issue a license at step S650. At step S650, where the license management module receives a request to issue a license from the home device seeking to play media files but the license does not exist in the license management module, the license management module requests the license server to issue the concerned license.

Then, the license server issues the formal license therefor at step S660. Next, for respective home devices to download contents thereonto, the license management module processes the issued license to issue respective temporary licenses at step S670. Finally, respective devices can play the same contents with their content players by use of the temporary licenses at step S680.

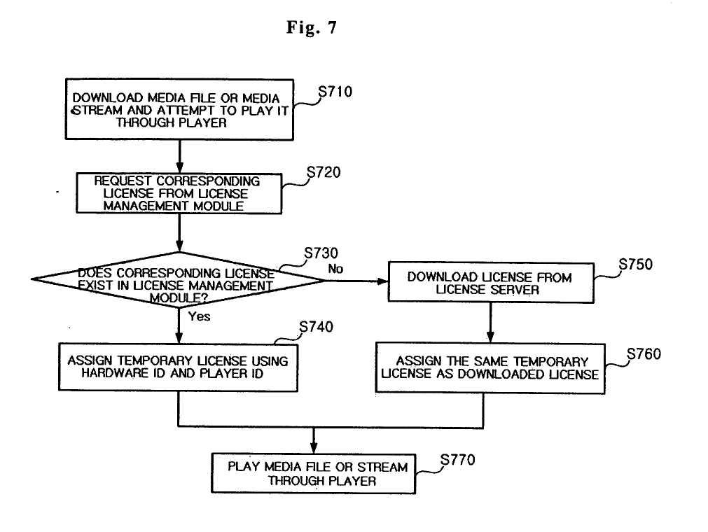

FIG. 7 is a flowchart showing steps of an exemplary, non-limiting embodiment of license management method of the present invention, on the basis of home networking. A single home device accesses the Web server or the media server to download and play a media file through a content player, or receives and attempts to play a transmitted media stream the media stream through the content player in real-time at step S710.

Since the home device has no license, it is not possible to play the media file or media stream, and thus, the home device requests the license management module to issue a license at step S720.

At step S730, the license search module in the license management module determines whether the requested license exists in the license storing module by searching for the requested license in the license storing module in response to the request. When the corresponding license does not exist in the license storing module, the license request module in the license management module requests the license server to issue the corresponding license and downloads the license therefrom at step S750. Further, the temporary license issuing module assigns a temporary license substantially similar to the downloaded license to the home device at step S760. Step S760 refers to a case where a license is requested for a single media file or media stream for the first time. In this case, since there is no problem even though the license issued from the license server is assigned to the home device as it is, the same temporary license as the downloaded license is assigned to the home device. Thereafter, the home device allows a content player to play the media file or media stream using the assigned temporary license at step S770.

When step S730 determines that the corresponding license exists in the license storing module, the home device is assigned a temporary license executable only in the home device using a hardware ID, a content player ID and a previously issued license of the home device from the license management module at step S740. The home device allows the content player to play the media file or media stream using the assigned acquired temporary license at step S770.

The foregoing invention can also be implemented in any computer readable medium, and further, the foregoing steps can be performed as a set of instructions in that computer readable medium.

The present invention has various advantages. As described above, the present invention provides a license management system and method for playing contents on the home network, in which all devices within the home network share a single license, thus making it convenient to play the same media file or media stream using a single license.

Further, the present invention is also advantageous in that a single license is used over an entire home network, thus distributing various playing conditions among respective home devices under the conditions of playing the convents over the whole home network. Further, management of the license is consolidated.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A license management apparatus for playing contents on a home network, comprising:
a license storing module that stores at least one formal license provided from a license server; and
a temporary license issuing module that issues at least one temporary license for use by at least one home device within the home network, based on the at least one formal license stored in the license storing module.

2. The apparatus according to claim 1, further comprising:
a license search module that receives a request to issue the formal license from the at least one home device, searches for the formal license in the license storing module and transmits the search result to a license request module and the temporary license issuing module; and
the license request module that requests the license server to issue the formal license that corresponds to the temporary license does not exist in the license storing module.

3. A license management system for playing contents on a home network, comprising:
a license server assigning at least one license corresponding to a device and contents;
a Web server providing a service to download the contents;
at least one home device, provided with a content player for playing a media file using the contents downloaded from the Web server and the at least one license assigned from the license server; and
a license management module allowing the at least one license assigned from the license server to be shared on the home network.

4. The system according to claim 3, further comprising a packaging server generating an encrypted form of the contents by packaging a raw form of the contents.

5. The system according to claim 3, further comprising a media server providing a service to stream the contents.

6. The system according to claim 3, wherein the license management module comprises:
a license storing module storing the at least one formal license provided from the license server; and
a temporary license issuing module issuing at least one temporary license for use by the at least one home device on the network using the at least one formal license stored in the license storing module.

7. The system according to claim 6, wherein the license management module further comprises:
a license search module receiving a request to issue the formal license from the at least one home device, searching for the formal license in the license storing module and transmitting the search result to a license request module and the temporary license issuing module; and
the license request module requesting the license server to issue the formal license that corresponds to the temporary license when the corresponding formal license does not exist in the license storing module.

8. A license management method for playing contents on a home network, comprising the steps of:
a) a home device requesting a license from a license management module;
b) determining whether the license exists in the license management module;
c) assigning a temporary license to the home device in accordance with the determination result; and
d) playing the contents by use of a content player in the home device.

9. The method according to claim 8, wherein, when the requested license does not exist in the license management module, step c) comprises the steps of:
downloading the requested license from a license server; and
assigning as the temporary license the requested license downloaded from the license server.

10. The method according to claim 8, wherein, when the corresponding license exists in the license management module, step c) comprises the step of:
assigning the temporary license in accordance with a hardware identification and a player identification.

11. The license management method according to claim 8, further comprising the steps of:
(e) packaging raw contents;
(f) distributing the packaged contents;
(g) setting up a license policy; and
(h) allowing the home device to download the contents, wherein steps (e)-(h) are performed prior to said step (a).

12. A computer readable recording medium configured for recording thereon computer programs including a series of steps for executing a license management method, said instructions comprising:
a) in a home device, requesting a license from a license management module;
b) determining whether the license exists in the license management module;
c) assigning a temporary license to the home device in accordance with the determination result; and
d) playing the contents by use of a content player in the home device.

13. The computer readable medium according to claim 12, wherein, when the requested license does not exist in the license management module, instruction c) comprises:
downloading the requested license from a license server; and
assigning as the temporary license the requested license downloaded from the license server.

14. The computer readable medium according to claim 12, wherein, when the corresponding license exists in the license management module, instruction c) comprises:
assigning the temporary license in accordance with a hardware identification and a player identification.

15. The computer readable medium according to claim 12, further comprising the instructions of:
(e) packaging raw contents;
(f) distributing the packaged contents;
(g) setting up a license policy; and
(h) allowing the home device to download the contents, wherein instructions (e)-(h) are performed prior to said instruction (a).
